(19) United States
(12) Patent Application Publication
(10) Pub. No.: US 2017/0147895 A1
(43) Pub. Date: May 25, 2017

(54) METHOD AND DEVICE FOR DIGIT SEPARATION

(71) Applicants: Le Holdings (Beijing) Co., Ltd., Beijing (CN); LE SHI ZHI XIN ELECTRONIC TECHNOLOGY (TIANJIN) LIMITED, Beijing (CN)

(72) Inventor: Xiaokun He, Beijing (CN)

(21) Appl. No.: 15/236,241

(22) Filed: Aug. 12, 2016

Related U.S. Application Data
(63) Continuation of application No. PCT/CN2016/088329, filed on Nov. 24, 2015.

(30) Foreign Application Priority Data
Nov. 24, 2015 (CN) 201510824285.5

(51) Int. Cl. G06K 9/46; G06T 7/00

(52) U.S. Cl. CPC G06K 9/4604; G06T 7/0081; G06T 7/0085; G06T 2207/10016; G06K 2209/01; G06K 2209/25

(57) ABSTRACT

Embodiments of the present disclosure provide a method and a device for digit separation, and relate to the technical field of information recognition. According to embodiments of the present disclosure, a sliding template matching method is not required. Instead, in one illustrative implementation, a station logo area and position information of the station logo area are obtained; position information of a digit area is determined according to a position relation between the station logo area and the digit area, and the position information of the station logo area; and the station logo area is then segmented according to the position information of the digit area to obtain the digit area. In such a manner, digit separation can be realized simply, and the efficiency of separation is improved.

### CROSS-REFERENCE TO RELATED APPLICATIONS

This application is a continuation of PCT International Patent Application No. PCT/CN2016/088329, filed Nov. 24, 2015 (attached hereto as an Appendix), published as ______, and is also based upon and claims priority to Chinese Patent Application No. 201510824285.5, filed on Nov. 24, 2015, all of which are incorporated herein by reference in entirety.

### BACKGROUND

Technical Field

The present disclosure relates to the technical field of information recognition, and in particular, to a method and a device for digit separation.

Description of Related Information

CCTV station logo is the most common television station logo in modern television. A certain classification method is designed according to such characteristics as shape and color, such that a station logo type can be screened from station logos, such as satellite television station logos, local television station logos, the CCTV station logo, and the like, as the CCTV station logo. However, for recognition between specific channels (e.g., “General Channel”, and “Sports Channel” of CCTV, a recognition method needs to be designed according to the difference between characters (e.g., “General”, and “Sports”) or digits (e.g., “1”, and “5”).

In the field of pattern recognition, certain techniques of recognizing digits may be relatively straightforward. The premise of the recognition of digits is separation of digits. In the prior art, for the recognition of a digit, a sliding template matching method is employed to find out and segment the digit in a station logo area, but has relatively high algorithm complexity, thereby leading to extremely low efficiency of digit separation.

### OVERVIEW OF SOME ASPECTS

The embodiments of the present disclosure provide a method and a device for digit separation, which are used to overcome the defects of extremely high algorithm complexity and extremely low efficiency of digit separation in the prior art.

One embodiment of the present disclosure provides a method for digit separation. The method includes:

obtaining a station logo area and position information of the station logo area;

determining position information of a digit area according to a position relation between the station logo area and the digit area, and the position information of the station logo area;

segmenting the station logo area according to the position information of the digit area to obtain the digit area.

One embodiment of the present disclosure provides a device for digit separation. The device includes:

a data obtaining unit configured to obtain a station logo area and position information of the station logo area;

a position determining unit configured to determine position information of a digit area according to a position relation between the station logo area and the digit area, and the position information of the station logo area;

an area segmenting unit configured to segment the station logo area according to the position information of the digit area to obtain the digit area.

One embodiment of the present disclosure provides a server, including:

a processor, a memory, a communication interface, and a bus,

wherein the communication interface is configured to transmit information between user equipment and a server;

wherein the processor is configured to call logical commands in the memory to execute a method including:

obtaining a station logo area and position information of the station logo area; determining position information of a digit area according to a position relation between the station logo area and the digit area, and the position information of the station logo area; segmenting the station logo area according to the position information of the digit area to obtain the digit area.

One embodiment of the present disclosure provides a computer program, including program codes for executing the following operations:

obtaining a station logo area and position information of the station logo area;

determining position information of a digit area according to a position relation between the station logo area and the digit area, and the position information of the station logo area;

segmenting the station logo area according to the position information of the digit area to obtain the digit area.

One embodiment of the present disclosure provides a computer-readable medium and/or a storage medium for storing the above computer program.

One embodiment of the present disclosure further provides a device for digit separation, comprising: one or more processors; a memory; and one or more units stored in the memory, the one or more units are configured to perform the following operations when being executed by the one or more processors: obtaining a station logo area and position information of the station logo area; determining position information of a digit area according to a position relation between the station logo area and the digit area, and the position information of the station logo area; segmenting the station logo area according to the position information of the digit area to obtain the digit area.

The processor is further configured to: perform noise and/or character removal processing on the station logo area.

The processor is further configured to: obtain a video frame image sequence from a preset area of a video comprising the CCTV station logo, perform edge extraction on various video frame images, composite edges of the various video frame images, obtain a minimum external matrix of a composited edge, separately segment the various video frame images according to the minimum external matrix, and composite the segmented images in a weighted average way to obtain the station logo area.

The processor is further configured to: perform binarization processing on a digit portion and a background portion in the digit area, and delete interference information from the binarized digit area.

According to the method and the device for digit separation provided by the present disclosure, the sliding template matching method is not required; instead, the station logo area and the position information of the station logo area are obtained; the position information of the digit area is determined according to the position relation between the station logo area and the digit area, and the position information of the station logo area; and the station logo area is then segmented according to the position information of the digit area to obtain the digit area. In such a manner, the digit separation can be realized simply, and the efficiency of separation is improved.

### BRIEF DESCRIPTION OF THE DRAWINGS

FIG. 1 is a flow diagram of a method for digit separation of one embodiment of the present disclosure.

FIG. 2 is a flow diagram of a method for digit separation of another embodiment of the present disclosure.

FIG. 3 is station logo example drawing of CCTV1.

FIG. 4 is station logo example drawing of CCTV2.

FIG. 5 is station logo example drawing of CCTV3.

FIG. 6 is an example drawing of a gray image including the station logo of CCTV1.

FIG. 7 is an example drawing of a digit area after digit separation is performed on the gray image as shown in FIG. 6.

FIG. 8 is an example drawing of a gray image including the station logo of CCTV5.

FIG. 9 is an example drawing of a digit area after digit separation is performed on the gray image as shown in FIG. 8.

FIG. 10 is an example drawing of a gray image including the station logo of CCTV8.

FIG. 11 is an example drawing of a digit area after digit separation is performed on the gray image as shown in FIG. 10.

FIG. 12 is an example drawing of a gray image including the station logo of CCTV15.

FIG. 13 is an example drawing of a digit area after digit separation is performed on the gray image as shown in FIG. 12.

FIG. 14 is a structure block diagram of a device for digit separation of one embodiment of the present disclosure.

FIG. 15 is a structural schematic diagram of a server of an embodiment of the present disclosure.

### DETAILED DESCRIPTION OF ILLUSTRATIVE IMPLEMENTATIONS

In order to make various objectives, technical solutions and/or advantages of the embodiments of the present disclosure more clear, the technical solutions in the embodiments of the present disclosure will be described below clearly and completely in conjunction with the accompanying drawings in the embodiments of the present disclosure. Apparently, the described embodiments are part of embodiments of the present disclosure, not all embodiments. On the basis of the embodiments in the present disclosure, all the other embodiments obtained by those of ordinarily skill in the art without creative work should fall into the scope of protection of the present disclosure.

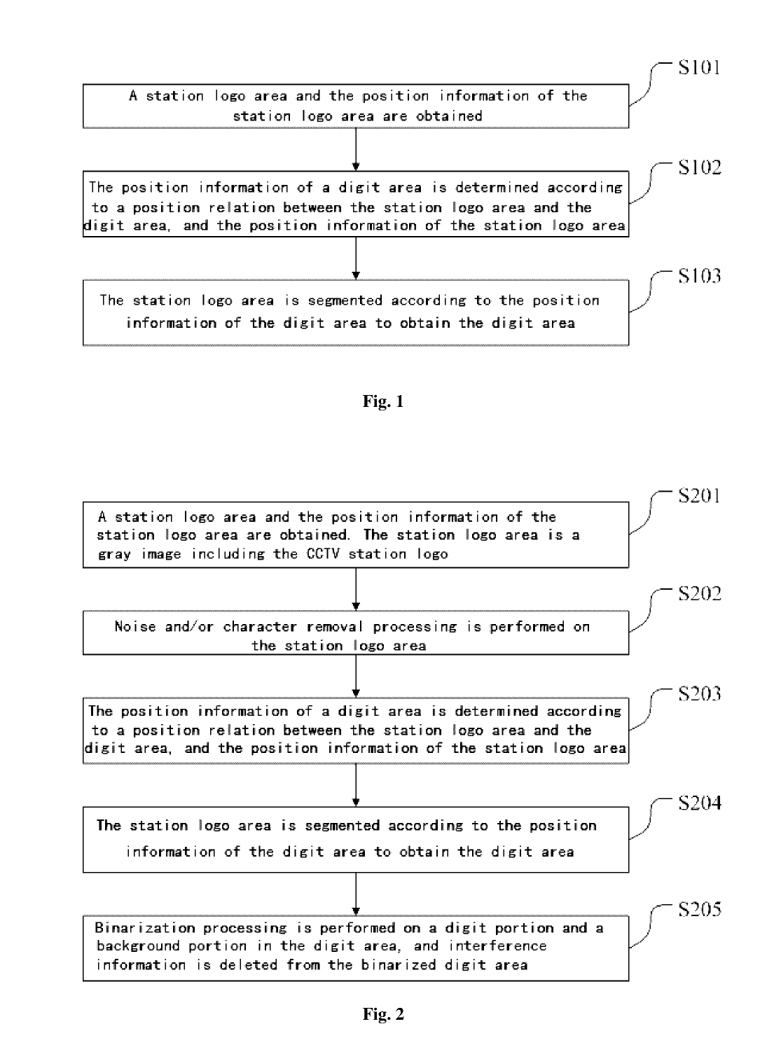

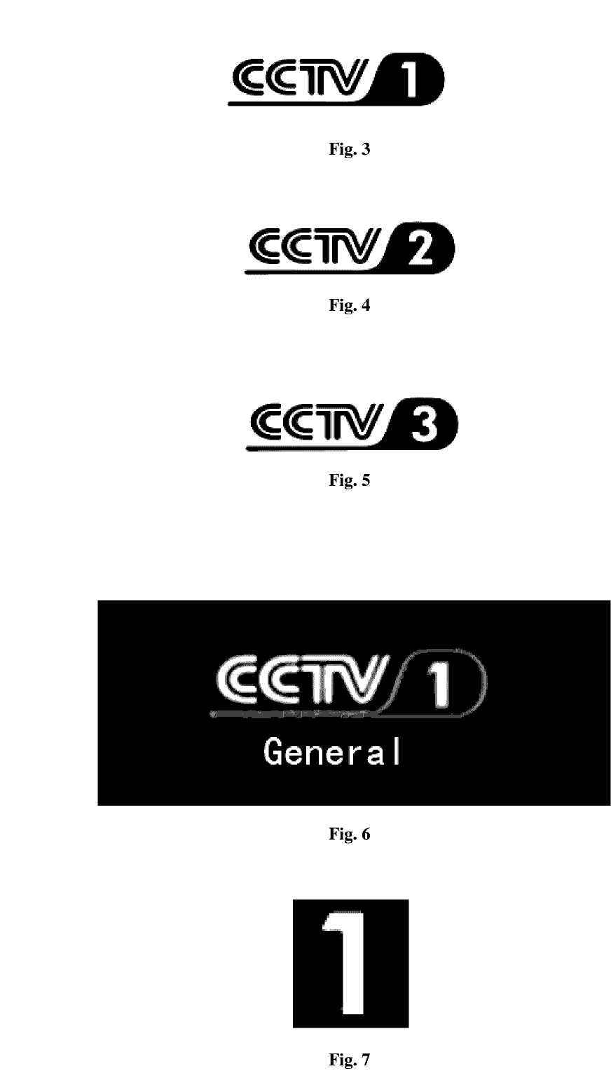

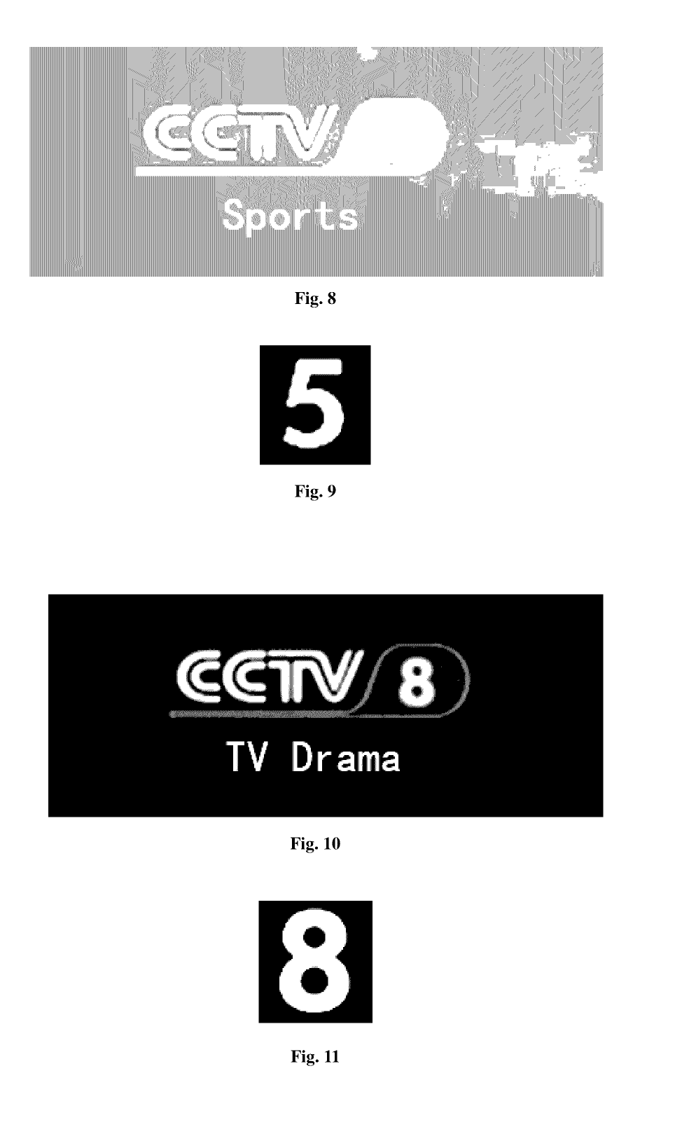

FIG. 1 is the flow diagram of the method for digit separation of one embodiment of the present disclosure. By referring to FIG. 1, the method includes:

S101: a station logo area and the position information of the station logo area are obtained.

It needs to be noted that the station logo area is an area including merely a station logo.

Understandably, the station logo area may be extracted in a variety of ways. In order to prevent the influence of such noise as random noise and image noise on station logo recognition, in the present embodiment, the station logo area is obtained by the following steps below:

(1) a video frame image sequence is obtained from a preset area of a video including the station logo.

According to the prior knowledge, every station logo is basically located at the top left corner of a video frame image (of course, if the station logo is located at other positions, it can just be adaptively adjusted as required), and therefore, during station logo detection, only the fixed top left corner area (serving as the preset area) needs to be extracted as a station logo detection area. In the prior art, the station logo area is obtained generally according to a golden section rule (GSR). The present embodiment differs from the prior art in that: (1) proportional positions of effective recognition of all station logos in various video frame images are calculated; (2) the maximum range of all the proportional positions is calculated to serve as an area for station logo area segmentation. Taking a 1920*1080 video as an example, the station logo segmentation area is defined by a line starting position 80(1/24), a column starting position 40(1/27), a line width 450(15/64), and a column width 180(1/6). Of course, the proportional positions can be adjusted appropriately according to requirements, which is not limited in the present embodiment.

For the sake of eliminating irrelevant information and recovering or enhancing useful relevant information in images, improving the detectability of characteristics, and simplifying data to an utmost extent to ensure the reliability of recognition, in the present embodiment, various video frame images may be preprocessed; the preprocessing includes at least one of area segmentation, graying, and image enhancement, and, of course, may also include other processing procedures, which is not limited in the present embodiment.

The preprocessing may be graying using a formula Gray=0.33R+0.59G+0.11B, and of course, by means of a three-channel average value method, a three-channel maximum method, or the like instead, wherein Gray is a gray value of a pixel; R is a red component of the pixel; G is a green component of the pixel; B is a blue component of the pixel.

The image enhancement is intended to highlight the effective information, such as an icon, characters, a digit and the like of the station logo area. The image enhancement is implemented by gray stretching at a gray scale of 0-255, which can also be replaced by a histogram transformation method.

(2) Edge extraction is performed on the various video frame images.

Understandably, the edge is where the gray of an image changes violently. The edge extraction is the key of the station logo recognition, and the integrity degree of the edge directly affects a station logo recognition result. Certainly, there are many edge extraction methods, such as Canny, LOG, Sobel, Laplace operator method, and the like. By comprehensively considering such requirements as noise removal, edge integrity, and edge positioning accuracy, the Canny edge detection method is adopted in the present embodiment.

In specific implementation, parameters used in the Canny edge detection method are set as follows: a weak edge threshold of 50, and a strong edge threshold of 200, which, of course, may fluctuate appropriately according to requirements. For example, the thresholds fluctuate within a range of +/−10.

(3) The edges of the various video frame images are composited.

In specific implementation, a corresponding preset image threshold may be determined according to the number of the video frame images, and a determination is made on whether each edge point is remained according to whether the number of the video frame images where the edge point appears is lower than the preset image threshold.

That is, a corresponding relation between the number of video frame images and a preset image threshold is established in advance, and the corresponding relation is found according to the number of the video frame images to determine the corresponding preset image threshold. When the number of the video frame images where an edge point appears is lower than the preset image threshold, the edge point is not remained; when the number of the video frame images where an edge point appears is higher than or equal to the preset image threshold, the edge point is remained.

The composition of the edges of the various video frame images will be described below with a specific embodiment, but the scope of protection of the present disclosure is not limited. N is assumed to be the number of the video frame images, while X is assumed to be the preset image threshold.

If N is equal to 6, accordingly, X is equal to 4. That is, only when an edge point exists in more than 4 (4 is included) video frame images, the edge point is remained. If an edge point exists in less than 3 (3 is included) video frame images, the edge point is abandoned.

If N is greater than 3 and less than 6, accordingly, X is equal to 3. That is, only when an edge point exists in more than 3 (3 is included) video frame images, the edge point is remained. If an edge point exists in less than 2 (2 is included) video frame images, the edge point is abandoned.

If N is less than or equal to 3, accordingly, X is equal to N. That is, only those edge points existing in all the video frame images are remained, and those edge points in other cases are all abandoned.

Of course, the parameters in the corresponding relation can be adjusted according to resolutions of images, which is not limited in the present embodiment.

Since edge noise, black edges, unessential characters, and so on all may affect the accuracy of recognition, in order to further improve the accuracy of recognition, optimization processing may be carried out for the composited edge. In the present embodiment, the optimization processing includes at least one of edge noise deletion, black edge removal, and unessential character deletion.

(4) A minimum external matrix of the composited edge is obtained.

(5) The various video frame images are separately segmented according to the minimum external matrix, and the segmented images are composited in a weighted average way to obtain the station logo area.

S102: the position information of a digit area is determined according to a position relation between the station logo area and the digit area, and the position information of the station logo area.

It can be appreciated that the digit area is located within and has a certain position relation to the station logo area, and therefore, the position relation between the station logo area and the digit area can be established in advance.

S103: the station logo area is segmented according to the position information of the digit area to obtain the digit area.

In the present embodiment, the sliding template matching method is not required; instead, the station logo area and the position information of the station logo area are obtained; the position information of the digit area is determined according to the position relation between the station logo area and the digit area, and the position information of the station logo area; the station logo area is then segmented according to the position information of the digit area to obtain the digit area. In such a manner, the digit separation can be realized simply, and the efficiency of separation is improved.

FIG. 2 is the flow diagram of the method for digit separation of another embodiment of the present disclosure. By referring to FIG. 2, the method includes:

S201: a station logo area and the position information of the station logo area are obtained. The station logo area is a gray image including the CCTV station logo that contains a logo (i.e., “CCTV”), characters, and a digit.

It needs to be noted that the position information of the station logo area typically includes width W_{A}, height H_{A}, and starting point coordinates (x_{A}, y_{A}).

S202: noise and/or character removal processing is performed on the station logo area.

It can be appreciated that since such noise as dotted noise or linear noise, and such information as the characters of the CCTV station logo may affect the determination of the position information of the digit area, in order to avoid the problem, the dotted noise and the linear noise can be removed by means of a connected domain approach.

In addition, because the characters of the CCTV station logo are generally located under the logo, and have an obvious pixel spacing with the logo, the part below the logo and exceeding a preset pixel spacing can be deleted to remove characters. Therefore, for the case of removing characters, the station logo area is merely an area including the digit and the logo of the CCTV station logo.

S203: the position information of a digit area is determined according to a position relation between the station logo area and the digit area, and the position information of the station logo area.

By referring to FIG. 3 to FIG. 5, corresponding relations between the digit area and the logo are as follows:

(1) the digit area is located on the right side of the logo, and the width of the digit area is equal to about ¼ of that of the logo;

(2) the digit area is as high as the logo, and the height of each of them is equal to about 0.8 of the overall height of the CCTV station logo.

The position relation between the station logo area and the digital area can be established according to the above corresponding relations. It can be appreciated that since the digit area is as high as the logo, the horizontal column coordinates of the digit area do not need to be considered. A is assumed to be the station logo area. P(x, y) represents pixel points belonging to the station logo area; x represents the vertical line coordinate of each pixel point, while y represents the horizontal column coordinate of the pixel point. The position of the digit area can be determined according to the following formula:

Area={P(x,y)|PεA,y_{A}+0.75W_{A}≦y≦y_{A}+W_{A}}

S204: the station logo area is segmented according to the position information of the digit area to obtain the digit area.

Step S204 is the same as step S103 in the embodiment as shown in FIG. 1, and thus not redundantly described herein.

S205: binarization processing is performed on a digit portion and a background portion in the digit area, and interference information is deleted from the binarized digit area.

It can be appreciated that in order to facilitate accurate recognition on the digit area, in the present embodiment, binarization processing is performed on the digit portion and the background portion in the digit area.

In addition, white pixel blocks/points may be formed easily at the positions of four corners of the digit area where noise points also exist, and the interference information may affect the digit recognition. In the present embodiment, the interference information is deleted from the binarized digit area.

In specific implementation, the white pixel blocks/points at the four corners of the digit area can be deleted according to a method as follows: it is assumed that the digit area has a horizontal width W (equal to 0.25W_{A}), and a vertical length H (equal to H_{A}); the gray value of each pixel point is gray (i, j), wherein i represents the vertical line coordinate of the pixel point, while j represents the horizontal column coordinate of the pixel point; the converted gray value is Gray(i, j).

$$Gray ( i , j ) = \{ \begin{matrix}0 , & if ( 0.2 H \geq i , 0.1 W \geq j or j \geq 0.9 W ) \\ 0 , & if ( 0.8 H \leq i , 0.1 W \geq j or j \geq 0.9 W ) \\ gray ( i , j ) , & else\end{matrix}$$

Noise filtering may be carried out for noise points in the digit area, thereby further weakening and reducing the influence of the noise points.

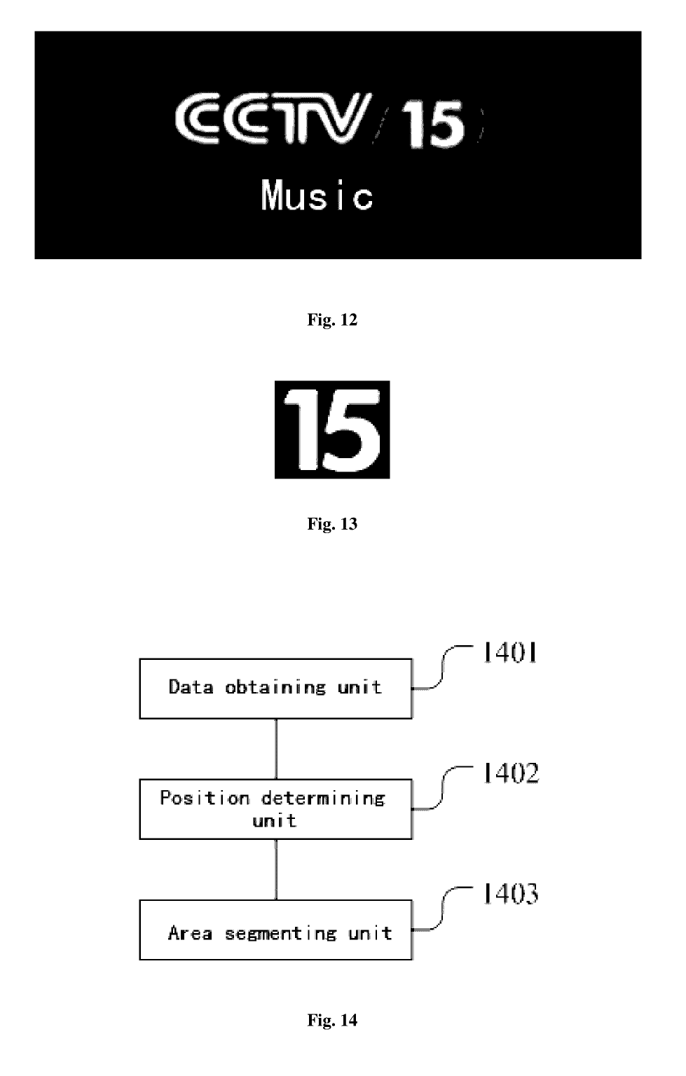

For the effects of the present embodiment, please see FIG. 6 to FIG. 13.

In regard of the method embodiments, for the sake of simple descriptions, they are all expressed as combinations of a series of actions; however, a person skilled in the art should know that the embodiments of the present disclosure are not limited by the described order of actions, because some steps may be carried out in other orders or simultaneously according to the embodiments of the present disclosure. For another, a person skilled in the art should also know that the embodiments described in the description all are optional embodiments, and the actions involved therein are not necessary for the embodiments of the present disclosure.

FIG. 14 is the structure block diagram of the device for digit separation of one embodiment of the present disclosure. By referring to FIG. 14, the device includes:

a data obtaining unit 1401 configured to obtain a station logo area and position information of the station logo area;

a position determining unit 1402 configured to determine position information of a digit area according to a position relation between the station logo area and the digit area, and the position information of the station logo area;

an area segmenting unit 1403 configured to segment the station logo area according to the position information of the digit area to obtain the digit area.

In an optional embodiment of the present disclosure, the station logo area is a gray image including the CCTV station logo that contains a logo, characters, and a digit.

In an optional embodiment of the present disclosure, the device further includes:

a preprocessing unit, configured to perform noise and/or character removal processing on the station logo area.

In an optional embodiment of the present disclosure, the data obtaining unit is further configured to obtain a video frame image sequence from a preset area of a video including the CCTV station logo, perform edge extraction on various video frame images, composite edges of the various video frame images, obtain a minimum external matrix of a composited edge, separately segment the various video frame images according to the minimum external matrix, and composite the segmented images in a weighted average way to obtain the station logo area.

In an optional embodiment of the present disclosure, the device also discloses:

a binarization processing unit configured to perform binarization processing on a digit portion and a background portion in the digit area, and delete interference information from the binarized digit area.

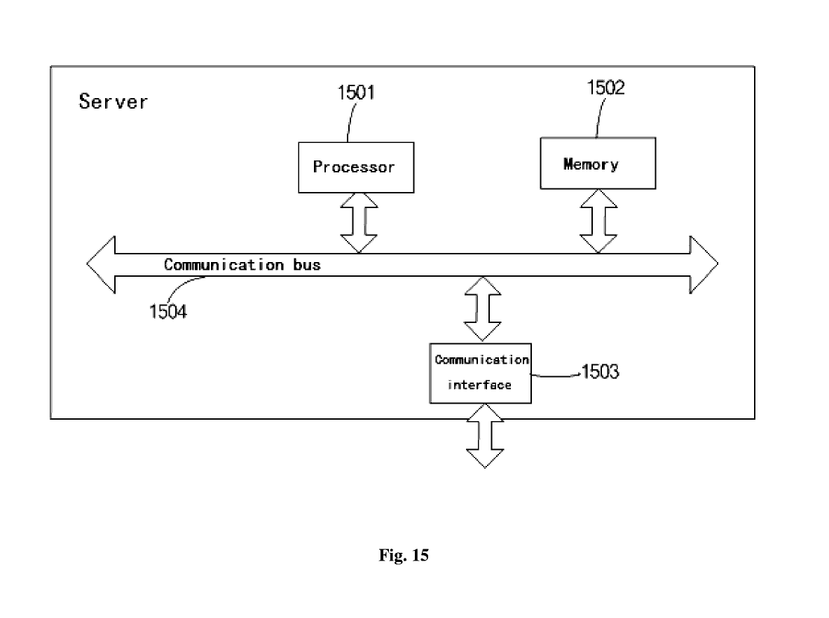

FIG. 15 illustrates the structural schematic diagram of the server of another embodiment of the present disclosure.

By referring to FIG. 15, the server includes:

a processor 1501, a memory 1502, a communication interface 1503, and a bus 1504, wherein

the processor 1501, the memory 1502, and the communication interface 1503 are in communication with each other by means of the bus 1504;

the communication interface 1503 is configured to transmit information between user equipment and a server;

the processor 1501 is configured to call logical commands in the memory 1502 to execute a method including:

obtaining a station logo area and position information of the station logo area; determining position information of a digit area according to a position relation between the station logo area and the digit area, and the position information of the station logo area; segmenting the station logo area according to the position information of the digit area to obtain the digit area.

By referring to FIG. 1, another embodiment of the present disclosure provides a computer program, including program codes for executing the following operations:

obtaining a station logo area and position information of the station logo area;

determining position information of a digit area according to a position relation between the station logo area and the digit area, and the position information of the station logo area;

segmenting the station logo area according to the position information of the digit area to obtain the digit area.

Another embodiment of the present disclosure provides a storage medium for storing the computer program described in the above embodiment.

It may be appreciated by those of ordinary skill in the art that the implementation of all or part of steps of the above method embodiments can be completed by means of program command related hardware, and the above program can be stored in a computer-readable storage medium, and may be executed to carry out the steps included in the above method embodiments. The above storage medium can be any one of various media capable of storing program codes, such as an ROM, an RAM, a magnetic disk, an optical disk, and the like.

It should be noted at last that the above embodiments are merely intended to illustrate the technical solutions of the present disclosure, and not meant to limiting. Although the embodiments of the present disclosure are described in detail with reference to the forgoing embodiments, it should be appreciated by those of ordinarily skill in the art that the technical solutions described in each forgoing embodiment still can be modified, or partial or all technical features therein may be equivalently substituted; and these modifications or substitutions do not cause the nature of the corresponding technical solutions to depart from the scope of the technical solutions in various embodiments of the present disclosure.

1. A method for digit separation, comprising:
obtaining a station logo area and position information of the station logo area;
determining position information of a digit area according to a position relation between the station logo area and the digit area, and the position information of the station logo area; and
segmenting the station logo area according to the position information of the digit area to obtain the digit area.

2. The method according to claim 1, wherein the station logo area is a gray image comprising CCTV station logo that contains a logo, characters, and a digit.

3. The method according to claim 2, before determining the position information of the digit area according to the position relation between the station logo area and the digit area, and the position information of the station logo area, further comprising:
performing noise and/or character removal processing on the station logo area.

4. The method according to claim 2, wherein the step of obtaining the station logo area further comprises:
obtaining a video frame image sequence from a preset area of a video comprising the CCTV station logo, performing edge extraction on various video frame images, compositing edges of the various video frame images, obtaining a minimum external matrix of a composited edge, separately segmenting the various video frame images according to the minimum external matrix, and compositing the segmented images in a weighted average way to obtain the station logo area.

5. The method according to claim 1, after segmenting the station logo area according to the position information of the digit area to obtain the digit area, further comprising:
performing binarization processing on a digit portion and a background portion in the digit area, and deleting interference information from the binarized digit area.

6. A device for digit separation, comprising:
one or more processors;
a memory; and
one or more units stored in the memory, the one or more units are configured to perform the following operations when being executed by the one or more processors:
obtaining a station logo area and position information of the station logo area;
determining position information of a digit area according to a position relation between the station logo area and the digit area, and the position information of the station logo area; and
segmenting the station logo area according to the position information of the digit area to obtain the digit area.

7. The device according to claim 6, wherein the station logo area is a gray image comprising CCTV station logo that contains a logo, characters, and a digit.

8. The device according to claim 7, wherein the processor is further configured to:
perform noise and/or character removal processing on the station logo area.

9. The device according to claim 8, wherein the processor is further configured to:
obtain a video frame image sequence from a preset area of a video comprising the CCTV station logo, perform edge extraction on various video frame images, composite edges of the various video frame images, obtaining a minimum external matrix of a composited edge, separately segment the various video frame images according to the minimum external matrix, and composite the segmented images in a weighted average way to obtain the station logo area.

10. The device according to claim 6, wherein the processor is further configured to:
perform binarization processing on a digit portion and a background portion in the digit area, and delete interference information from the binarized digit area.

11. A server, comprising:
a processor, a memory, a communication interface, and a bus,
wherein the communication interface is configured to transmit information between user equipment and a server;
wherein the processor is configured to call logical commands in the memory to execute a method comprising:
obtaining a station logo area and position information of the station logo area;
determining position information of a digit area according to a position relation between the station logo area and the digit area, and the position information of the station logo area;
segmenting the station logo area according to the position information of the digit area to obtain the digit area.

12. The method according to claim 1, before determining the position information of the digit area according to the position relation between the station logo area and the digit area, and the position information of the station logo area, further comprising:
performing noise and/or character removal processing on the station logo area.

13. The method according to claim 1, wherein the step of obtaining the station logo area further comprises:
obtaining a video frame image sequence from a preset area of a video comprising the CCTV station logo, performing edge extraction on various video frame images, compositing edges of the various video frame images, obtaining a minimum external matrix of a composited edge, separately segmenting the various video frame images according to the minimum external matrix, and compositing the segmented images in a weighted average way to obtain the station logo area.

14. The method according to claim 1, wherein the station logo area is a gray image comprising a station logo that contains a logo, characters, and a digit.

15. The method according to claim 14, before determining the position information of the digit area according to the position relation between the station logo area and the digit area, and the position information of the station logo area, further comprising:
performing noise and/or character removal processing on the station logo area.

16. The method according to claim 14, wherein the step of obtaining the station logo area further comprises:
obtaining a video frame image sequence from a preset area of a video comprising the CCTV station logo, performing edge extraction on various video frame images, compositing edges of the various video frame images, obtaining a minimum external matrix of a composited edge, separately segmenting the various video frame images according to the minimum external matrix, and compositing the segmented images in a weighted average way to obtain the station logo area.

17. The method according to claim 14, after segmenting the station logo area according to the position information of the digit area to obtain the digit area, further comprising:
performing binarization processing on a digit portion and a background portion in the digit area, and deleting interference information from the binarized digit area.

18. The method according to claim 17, before determining the position information of the digit area according to the position relation between the station logo area and the digit area, and the position information of the station logo area, further comprising:
performing noise and/or character removal processing on the station logo area.

19. The method according to claim 18, wherein the step of obtaining the station logo area further comprises:
obtaining a video frame image sequence from a preset area of a video comprising the CCTV station logo, performing edge extraction on various video frame images, compositing edges of the various video frame images, obtaining a minimum external matrix of a composited edge, separately segmenting the various video frame images according to the minimum external matrix, and compositing the segmented images in a weighted average way to obtain the station logo area.

20. The method according to claim 19, further comprising:
performing noise and character removal processing on the station logo area.
